(19) United States
(12) Patent Application Publication
(10) Pub. No.: US 2012/0143966 A1
(43) Pub. Date: Jun. 7, 2012

(54) APPARATUS AND METHOD OF GENERATING AN SMS MESSAGE

(75) Inventor: Sung Bo Yang, Seoul (KR)

(73) Assignees: KIA MOTORS CORPORATION, Seoul (KR); HYUNDAI MOTOR COMPANY, Seoul (KR)

(21) Appl. No.: 13/090,648

(22) Filed: Apr. 20, 2011

(30) Foreign Application Priority Data
Dec. 7, 2010 (KR) 10-2010-0124521

(51) Int. Cl. G06F 15/16

(52) U.S. Cl. 709/206

(57) ABSTRACT

An apparatus for generating a short message service (SMS) message including a message abbreviation unit, a message compression unit, a data segmentation unit and an SMS transmission unit. The message abbreviation unit generates an abbreviated message based on method information, a uniform resource locator (URL), header information and a body included in a hypertext transfer protocol (HTTP) based message. The message compression unit compresses the abbreviated message into binary data by, e.g., using a deflate compression algorithm. The data segmentation unit segments the binary data to generate a segmented packet including a header and a binary chunk. The SMS transmission unit transmits the segmented packet in a form of the SMS message.

### CROSS-REFERENCES TO RELATED APPLICATIONS

Priority to Korean Patent Application Number 10-2010-0124521, filed on Dec. 7, 2010, which is incorporated herein by reference in its entirety, is claimed.

### BACKGROUND OF THE INVENTION

1. Field of the Invention

The present invention relates to an apparatus and a method of generating one or more Short Message Service (SMS) messages using representational state transfer (REST), and more particularly, to an apparatus and a method of generating an SMS message in which an HTTP based message is abbreviated and compressed into an SMS message to be sent between a telematics server and a terminal.

2. Description of the Related Art

A telematics service are able to provide a vehicle user with various information such as vehicle maintenance information or vehicle diagnosis information and various navigation functions via a wireless network. For example, a user connects to a telematics server by using a terminal provided within a vehicle to send and receive a data. In performing data transmission between the telematics server and the terminal, the terminal can be embodied as either a vehicle terminal or a smartphone that consumes less computing resources and the wireless network supports for a lower speed data communication.

Representational state transfer (REST) is a model for transmitting a data in a JavaScript object notation (JSON) format across a general purpose standardized interface, such as, hypertext transfer protocol (HTTP). The REST enables the user to easily access a webpage provided by the telematics server by using a uniform resource locator (URL) of the webpage.

When sending an HTTP based message, however, there is a need for a method of generating and transmitting such a message in a more simplified manner by using the REST and then promptly transmitting the message by using a conventional wireless network, thereby maintaining the telematics service even faster and more easy to use.

### SUMMARY OF THE INVENTION

The present invention provides an apparatus and a method of generating an SMS message using representational state transfer (REST) in which an HTTP based message is transmitted in a form of an SMS message, thereby providing a telematics service that has an increased ease of user and faster data communication performance between a telematics server and a terminal.

In accordance with an aspect of the present invention, an apparatus for generating a short message service (SMS) message includes a message abbreviation unit, a message compression unit, a data segmentation unit, and an SMS transmission unit. More specifically, the message abbreviation unit generates an abbreviated message based on method information, a uniform resource locator (URL), header information, and a body included in a hypertext transfer protocol (HTTP) based message. The abbreviated message is then compressed by the message compression unit into binary data by using, e.g., a deflate compression algorithm. The binary data is then segmented by a data segmentation unit to generate a segmented packet including a header and a binary chunk. The segmented packet is then transmitted in the form of an SMS message via the SMS transmission unit.

### BRIEF DESCRIPTION OF THE DRAWINGS

The objects, features and advantages of the present invention will be more apparent from the following detailed description in conjunction with the accompanying drawings, in which:

FIG. 1 is a view illustrating a configuration of an apparatus for generating an SMS message according to an exemplary embodiment of the present invention;

FIG. 2 is a flowchart diagram illustrating a method of generating an SMS message according to an exemplary embodiment of the present invention; and

FIG. 3 is a view illustrating an HTTP based message and an abbreviated message according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

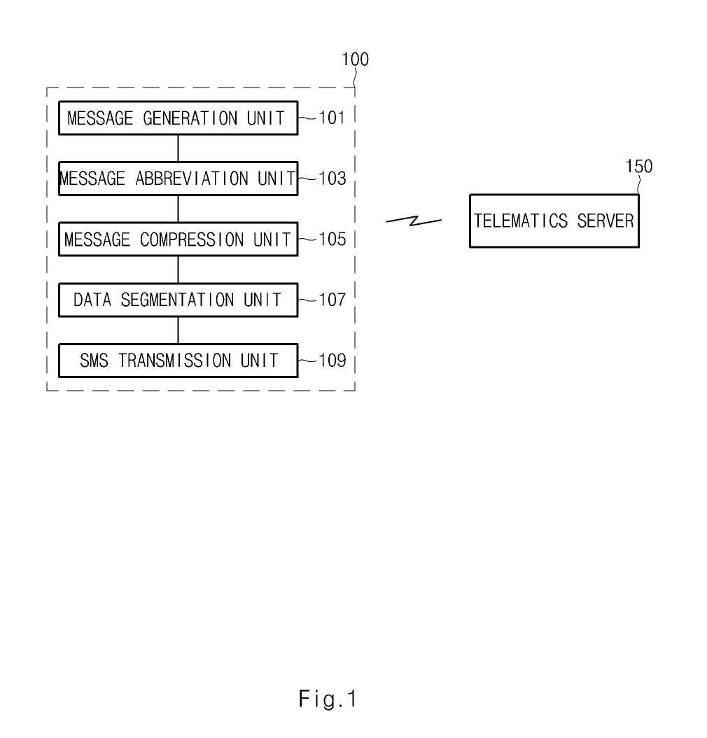

FIG. 1 is a view illustrating a configuration of an apparatus for generating an SMS message according to an exemplary embodiment of the present invention.

As shown in FIG. 1, a transmission message generating apparatus 100 includes a message generation unit 101, a message abbreviation unit 103, a message compression unit 105, a data segmentation unit 107 and a short message service (SMS) transmission unit 109. The transmission message generating apparatus 100 is positioned within a terminal that is used to communicate with a telematics server 150.

In the illustrative embodiment of the present invention, the message generation unit 101 generates an HTTP based message in order to create a transmission message. Alternatively, a message produced by abbreviating information included in the HTTP based message can also be generated. The HTTP based message may include method information, a uniform resource locator (URL), header information, and/or a body, which are requested by a user from the telematics server 150.

The message abbreviation unit 103 generates an abbreviated message by using the method information, the URL, the header information and the body included in the HTTP based message. In some embodiment of the present invention, the abbreviated message may include an inherent definition of the method information, the URL, the header information and the body included in the HTTP based message. For example, the method information encoded in HTTP verbs such as GET, POST, PUT and DELETE of the HTTP based message can be defined as 0, 1, 2 and 3, respectively, in the abbreviated message. Namely, identical information can be represented differently in the abbreviated message and the HTTP based message.

The message compression unit 105 converts the abbreviated message to binary data by using, e.g., a deflate compression algorithm. The deflate compression algorithm is given only for illustrative purposes and all other algorithms for HTTP data compression can be employed by the message compression unit 105.

The data segmentation unit 107 then segments the compressed binary data to generate a segmented packet. The segmented packet may include a header and a binary chunk. In this case, the header represents an order of respective segmented packets being assembled and the binary chunk includes an actual data to be transmitted. The segmented packets are then transmitted to the telematics server 150 in a form of an SMS message by the SMS transmission unit 109.

The apparatus and the method of generating the SMS message according to the present invention is not limited to a telematics service, however, but can also be applied to any field in which the HTTP based message is converted to the SMS message to be transmitted.

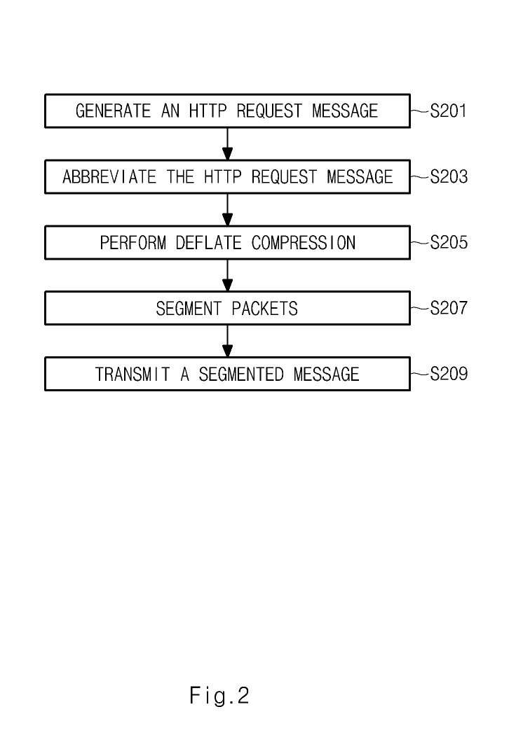

FIG. 2 is a flowchart diagram illustrating a method of generating an SMS message according to an exemplary embodiment of the present invention. Here, an apparatus and a method for SMS transmission in which an HTTP request message is transmitted in an SMS form are described.

First, data to be transmitted is generated as an HTTP request message (S201). In the present invention, the data to be transmitted can be generated in the abbreviated message form instead of the HTTP request message.

Next, the generated HTTP request message is abbreviated (S203). This abbreviated message is generated based on the method information, the URL, the header information and the body, included in the HTTP request message.

For exemplary purposes, a configuration of the abbreviated message is shown below in Table 1.

TABLE 1

| Contents | Remarks | Example | Optional |
|---|---|---|---|
| Method | 0, 1, 2, 3 for | 1 | No (Essential) |
| information | GET, POST, | | |
| | PUT, DELETE | | |
| URL [NL] | Other than | /service [symbol] n | No (Essential) |
| | schema and port | | |
| Header [NL] | key: value | TID: 123 [symbol] n | Yes(Optional) |
| | (no space) | | |
| [NL] Body | JSON data | [symbol] n{“key”: true} | Yes(Optional) |

As shown in Table 1, the abbreviated message may have a configuration of method information+URL+header information+body. The abbreviated message can use the same code implemented in the HTTP based message or, alternatively, use another code that corresponds to respective information such as, for example, the method information. As shown in Table 1, when the method information is represented in numbers, an amount of data in the header of the abbreviated message can be reduced accordingly.

Also in Table 1, the body can be embodied as a JavaScript object notation (JSON) data and [NL] indicates a new line and is represented as Wn.

Next, the abbreviated message is compressed into binary data by using, e.g., a deflate compression algorithm (S205) and the binary data is segmented to generate the segmented packet (S207). The segmented packet, as indicated above, may include a header and a binary chunk, and the header may further include a message ID and an SMS index. The binary chunk, on the other hand, includes information to be transmitted.

The information included in the segmented packet is shown in Table 2 below.

TABLE 2

| Category | Size (byte) | Context | | type |
|---|---|---|---|---|
| Header | 1 | Message ID | | unsigned |
| | | | | byte |
| Header | 1 | SMS Index | Others | unsigned |
| | | (4 bit) | (4 bit) | byte |

| | | | |
|---|---|---|---|
| Binary | 0 ≦ Binary Chunk ≦ | Segmented parts of | String |
| Chunk | (Size of the | compressed data | |
| | SMS-Header) | | |

As shown in Table 2, an entire size of the header and the binary chunk should be smaller than that of the SMS message. Additionally, the message ID is an identifier of whether the packet belongs to the same message, and the SMS index indicates an order of respective packets being assembled in the message.

Next, the segmented packets are transmitted to the telematics server 200 in a form of the SMS message (S209). Therefore, the HTTP based message can be transmitted to the telematics server in the form of the SMS message through processes of abbreviation, compression and segmentation.

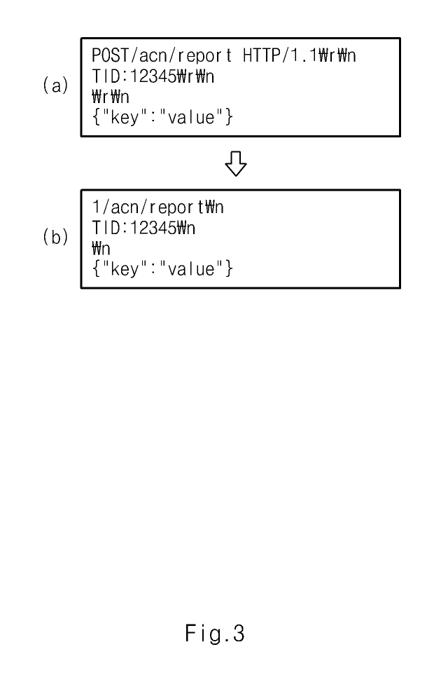

FIG. 3 is a view illustrating an HTTP based message and an abbreviated message according to an exemplary embodiment of the present invention.

In FIG. 3, (a) denotes a phase representing an HTTP request message prior to abbreviation. In FIG. 3, (b) denotes an abbreviated message generated by using the method information, the URL, the header information and the body in the HTTP request message.

Furthermore, the present invention may be embodied as computer readable media storage on a computer readable medium containing executable program instructions executed by a processor. Examples of the computer readable recording mediums include ROM, RAM, compact disc (CD)-ROMs, magnetic tapes, floppy disks, and optical data storage devices. The computer readable recording medium can also be distributed in network coupled computer systems so that the computer readable media is stored and executed in a distributed fashion.

Advantageously, the present invention provides a technique for providing data communication between the telematics server and the terminal for receiving the telematics service can be performed in a faster and simpler manner than the conventional techniques by utilizing an SMS message, while at the same time reducing a system load because a size of the transmitted data is also reduced. Also, in the present invention, the HTTP based message may be abbreviated, thereby facilitating development of the telematics service.

Therefore, a user can promptly receive the telematics service through an SMS message and data transmission for providing the telematics service is performed over a network in a simpler manner, thereby ensuring more stable system operation.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for generating a short message service (SMS) message, the apparatus comprising:
a message abbreviation unit configured to generate an abbreviated message based on method information, a uniform resource locator (URL), header information and a body included in a hypertext transfer protocol (HTTP) based message;
a message compression unit configured to compress the abbreviated message into binary data by using a deflate compression algorithm;
a data segmentation unit configured to segment the binary data to generate a segmented packet including a header and a binary chunk; and
an SMS transmission unit configured to transmit the segmented packet in a form of the SMS message.

2. The apparatus according to claim 1, wherein the message abbreviation unit is configured to generate the abbreviated message by using an inherent definition of the method information, the URL, the header information and the body.

3. The apparatus according to claim 1, wherein the method information of GET, POST, PUT and DELETE are represented as 0, 1, 2 and 3, respectively, in the abbreviated message.

4. The apparatus according to claim 1, wherein the header includes a message ID and an SMS index.

5. The apparatus according to claim 1, wherein an entire size of the header and the binary chunk of the segmented packet does not exceed a size of the SMS message.

6. The apparatus according to claim 1, further comprising a message generation unit configured to generate the HTTP based message.

7. The apparatus according to claim 1, wherein the body is embodied as JavaScript object notation (JSON) data.

8. The apparatus according to claim 1, wherein the SMS message is transmitted to a telematics server.

9. A method of generating a short message service (SMS) message, the method comprising:
generating, by a first unit, an abbreviated message based on method information, a uniform resource locator (URL), header information and a body included in a hypertext transfer protocol (HTTP) based message;
compressing, by a second unit, the abbreviated message into a binary data by using a deflate compression algorithm;
segmenting, by a third unit, the binary data to generate a segmented packet including a header and a binary chunk; and
transmitting, by a fourth unit, the segmented packet in a form of the SMS message.

10. The method according to claim 9, wherein the message abbreviation unit is configured to generate the abbreviated message by using an inherent definition of the method information, the URL, the header information and the body.

11. The method according to claim 9, wherein the method information of GET, POST, PUT and DELETE are represented as 0, 1, 2 and 3, respectively, in the abbreviated message.

12. The method according to claim 9, wherein the SMS message is transmitted to a telematics server.

13. A computer readable medium containing executable program instructions executed by a processor; comprising:
program instructions that generate an abbreviated message based on method information, a uniform resource locator (URL), header information and a body included in a hypertext transfer protocol (HTTP) based message;
program instructions that compress the abbreviated message into binary data;
program instructions that segment the binary data to generate a segmented packet including a header and a binary chunk; and
program instructions that transmit the segmented packet in a form of the SMS message.

14. The computer readable medium of claim 13 further comprising program instructions that generate the abbreviated message by using an inherent definition of the method information, the URL, the header information and the body.

15. The computer readable medium of claim 13 wherein the abbreviated message is compressed into binary data by using a deflate compression algorithm.
